(19) United States
(12) Patent Application Publication
(10) Pub. No.: US 2015/0038019 A1
(43) Pub. Date: Feb. 5, 2015

(54) TRIPLE EXTENSION ADAPTOR

(71) Applicant: XYZ Science Co., Ltd., New Taipei City (TW)

(72) Inventors: CHIU-SAN LEE, New Taipei City (TW); YI-HSUN LEE, New Taipei City (TW)

(73) Assignee: XYZ SCIENCE CO., LTD., New Taipei City (TW)

(21) Appl. No.: 13/958,621

(22) Filed: Aug. 5, 2013

(51) Int. Cl. H01R 24/00

(52) U.S. Cl. CPC H01R 24/00
USPC 439/640

(57) ABSTRACT

The present invention relates to a triple extension adaptor including a cover forming a plurality of socket ports in different shapes, a bottom assembled with the cover, a receipt compartment within the bottom and with an opening at side, a rotary plug within the receipt compartment wherein a overload tripping switch is used along with a capacitor and a surge arrestor for safety. An earth connection is for effective earthing of German or French plugs while the rotary plug can connect to an electrical wire or a wall socket. The present invention can accommodate multiply plugs in different shapes, connect to a power supply wire as extension cord for either construction or household by user and have an earth lip at the surface for receiving the German or French plugs with earth connection for advantages of reducing inventory and industrial application of non-permanent sockets.

### TECHNICAL FIELD OF THE INVENTION

The present invention is to provide a triple extension adaptor, and particularly a triple extension adaptor to be used as the expansion sockets accommodating multiply plugs in different shapes, wiring apparatus and extension cord at the same time.

### DESCRIPTION OF THE PRIOR ART

It is common to use an extension cord with multiply sockets when the number of power supply sockets on the wall is not sufficient for appliance and computer peripherals. Furthermore the resistance of the extension cord reduces the supply voltage and thus affects the ampere in use. Thus there is a need for an optimum design by those who in this art to resolve the aforesaid deficiency of the prior art.

### SUMMARY OF THE INVENTION

An objective of the present invention is to provide a triple extension adaptor for accommodating multiply plugs in different shapes, connecting a power supply wire as extension cord for either construction or household applications by users and having an earth lip provided at the surface of sockets so as to receive the plugs of German or French specifications with an earth connection.

The primary structure of the present invention for achieving the aforesaid objective includes a cover that forms a plurality of sockets in different shapes, a bottom assembled with the cover, a receipt compartment positioned within the bottom and provided with an opening at one side and a rotary plug positioned within the receipt compartment, wherein a overload tripping switch is used along with a capacitor and a surge arrestor as the safety measures. Further a design of earth connection is utilized for the plugs of German or French specifications for effective earthing while the rotary plug can connect to a power supply wire or insert into a wall socket. The features of the present invention is one extension adaptor for three different applications of accommodating multiply plug in different shapes, connecting a power supply wire as extension cord for construction or household applications and having an earth lip provided at the surface of sockets so as to receive the plugs of German or French specifications with an earth connection. The present invention is to be used and comply with the plugs in different shapes used in different countries for the practical advantage of reducing inventory and industrial application of non-permanent sockets at a construction site.

### BRIEF DESCRIPTION OF THE DRAWINGS

FIG. 1 is an upper perspective view illustrating the present invention.

FIG. 2 is a lower perspective view illustrating the present invention.

FIG. 2A is a lower perspective view illustrating the concealed lead shield of the present invention.

FIG. 3 is a perspective view illustrating the concealed cover and bottom of the present invention.

FIG. 4 is a bird view illustrating the concealed cover of the present invention.

FIG. 5 is a side view illustrating the concealed cover of the present invention.

FIG. 6 is a lookup view illustrating the concealed bottom of the present invention.

FIG. 7 is a side view illustrating the rotary plug of the present invention.

FIG. 8A is a side view illustrating the connection with a plug from top of the present invention.

FIG. 8B is a perspective view illustrating the connection with a plug from top of the present invention.

FIG. 9 is a side view illustrating the connection with a plug from a side of the present invention.

FIG. 10 is a schematic view illustrating the embodiment of a rotary plug in turned position of the present invention.

FIG. 11 is a schematic view illustrating the embodiment of a rotary plug connected on a socket of the present invention.

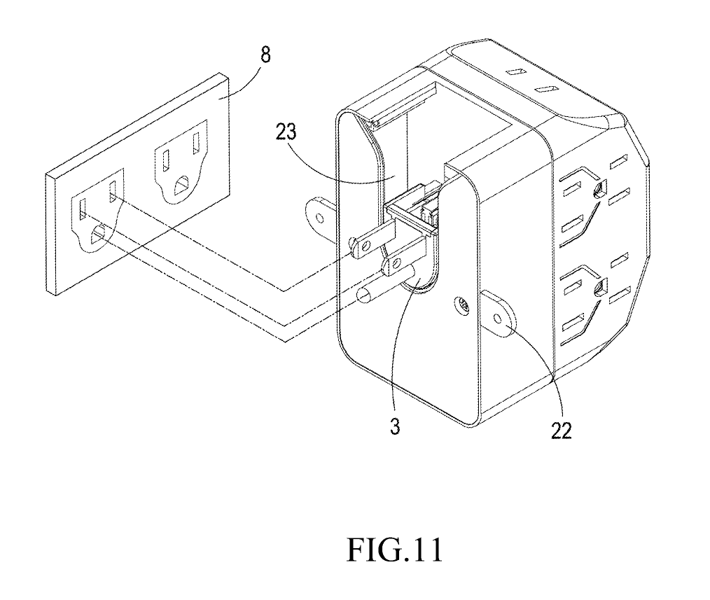

FIG. 12 is a schematic view illustrating the embodiment of extension cord of the present invention.

FIG. 13 is a schematic view illustrating the first preferred embodiment of the present invention.

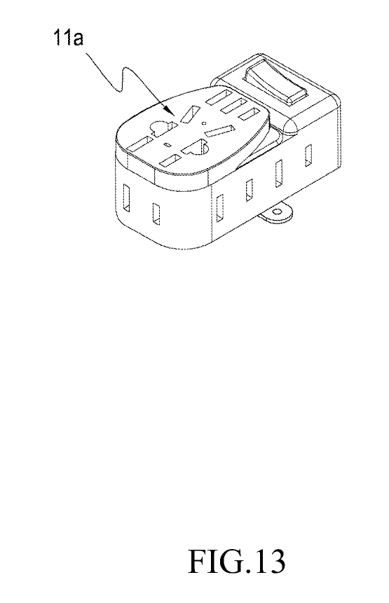

FIG. 14 is a schematic view illustrating the second preferred embodiment of the present invention.

FIG. 15 is a schematic view illustrating the third preferred embodiment of the present invention.

FIG. 16 is a schematic view illustrating the fourth preferred embodiment of the present invention.

FIG. 17 is a schematic view illustrating the fifth preferred embodiment of the present invention.

FIG. 18 is a schematic view illustrating the sixth preferred embodiment of the present invention.

### BRIEF DESCRIPTION OF THE DRAWING ELEMENTS

1 cover
11, 11a socket port
2 bottom
21 terminal stand
22 securing flange
231 opening
23 receipt compartment
24 bottom plate
25 lead shield
251 lead opening
3 rotary plug
31 plug rod
32 plug connector
33 terminal clamp
4 wiring post
5 first NL terminal
51 first clamp lip
52 earth point
53 earth lip
6 second NL terminal
61 second clamp lip
7 plug
71 conducting terminal
8 wall socket
9 power supply wire

### DETAILED DESCRIPTION OF THE PREFERRED EMBODIMENTS

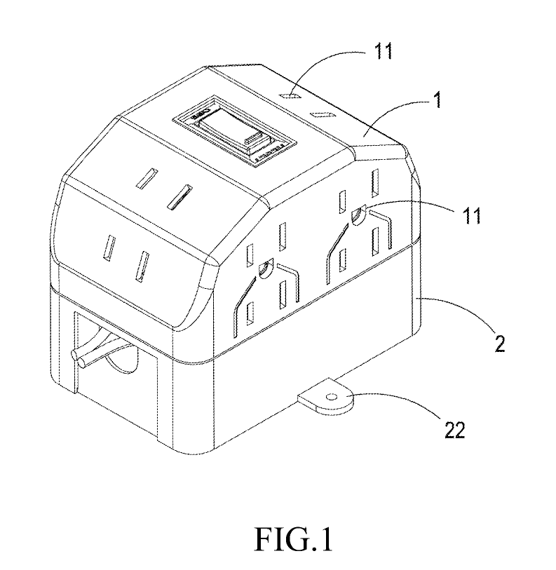

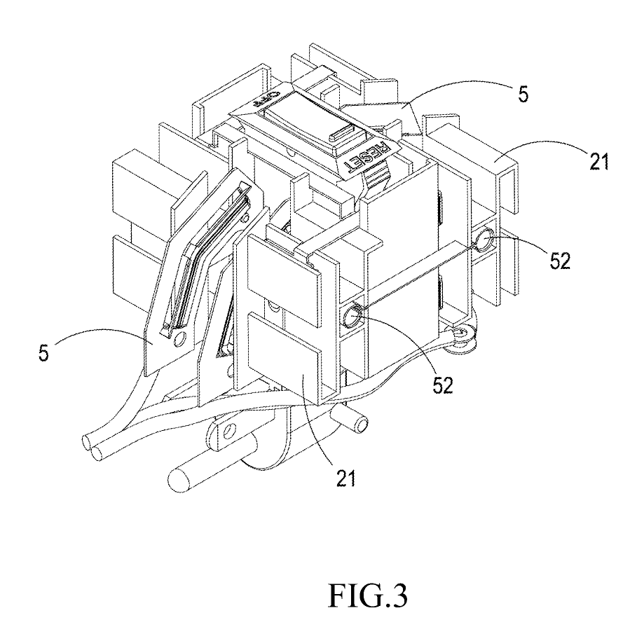

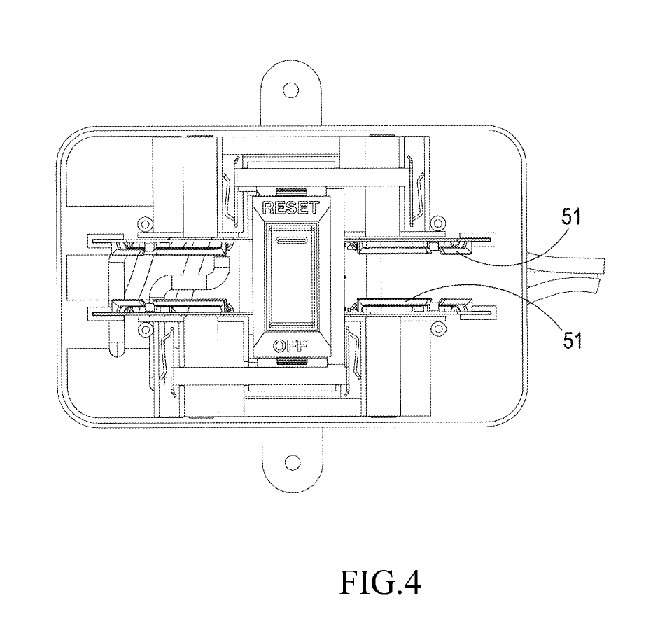

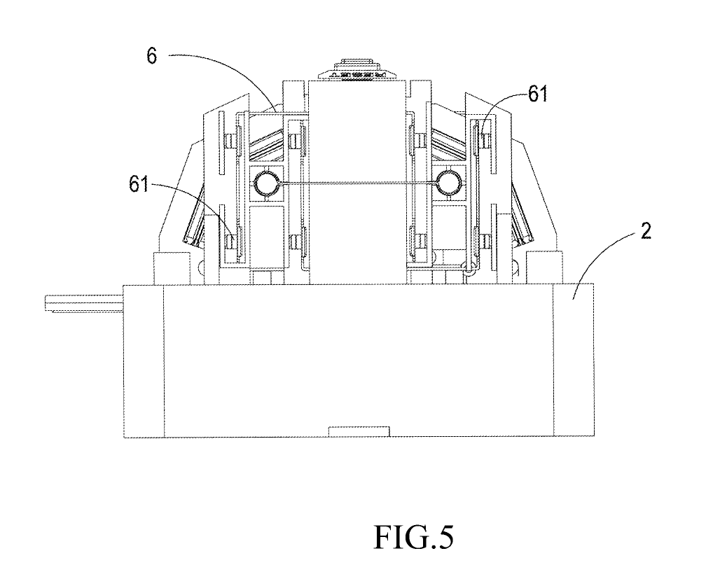

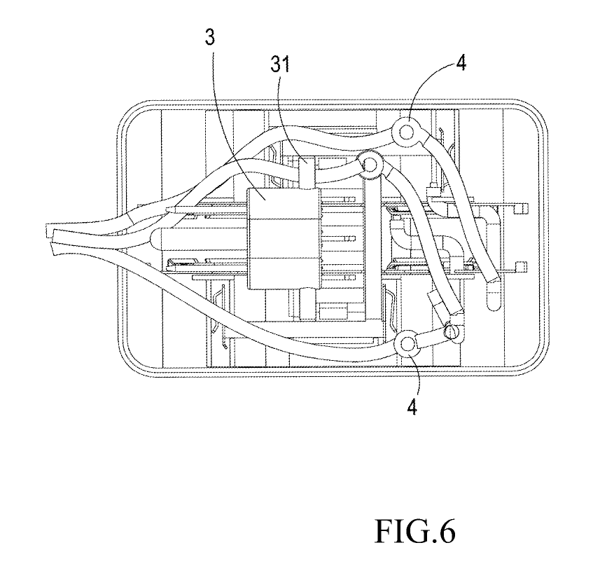

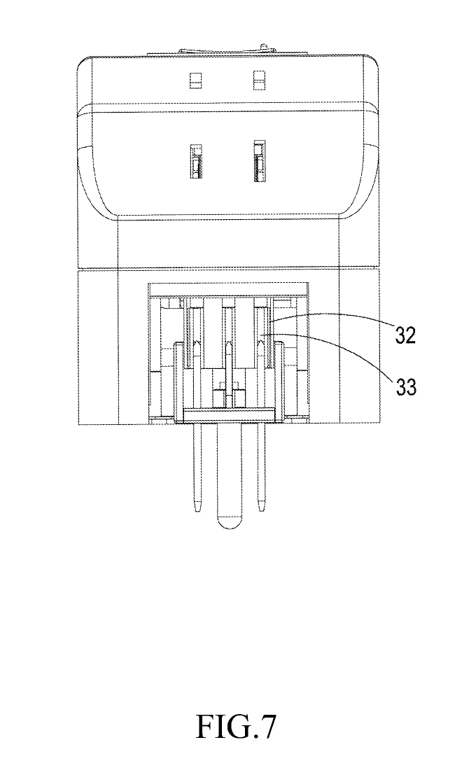

Please refer FIG. 1 to 7 for clear depiction of the present invention, triple extension adaptor. The triple extension adaptor includes a cover 1 forming a plurality of socket ports 11 in different shapes, that the socket ports 11 can be designed to comply with the plugs in different shapes used in different countries, a bottom 2 assembled with the cover 1 and provided with a terminal stand 21 for connecting with different terminals within the bottom 2, which is further provided with at least a securing flange 22 at one side, a receipt compartment 23 positioned within the bottom 2 and provided with an opening 231 at one side, a bottom plate 24 secured to the bottom 2, a rotary plug 3 positioned within the receipt compartment 23 and pivotally connected to the bottom 2 through a plug rod 31 and electrically connected to a plug connector 32, which is also positioned within the receipt compartment 23 and further secured and electrically connected to a terminal clamp 33, a wiring post 4 for securing an electrical wire for construction application, a plurality of first NL terminals 5 in semi-sphere shape positioned within the receipt compartment 23 with respect to the socket ports 11, that the first NL terminals 5 having at least a first clamp lip 51 for securing a plug in position and being positioned within the terminal stand 21, a plurality of second NL terminals 6 in [symbol] shape positioned within the receipt compartment 23 with respect to the socket port 11, that the second NL terminals 6 having at least a second clamp lip 61 for securing a plug in position and being positioned within the terminal stand 21, and a lead shield 25 snapped to the bottom 2 for covering the opening 231 so as to constitute a lead opening 251 and prevent the short circuit from improper contact of wires as positioned over the rotary plug 3 for achieving the safety in application.

In addition, aforesaid terminal stand 21 provides both the first NL terminals 5 and second NL terminals 6 together with a earth point 52 (E terminal).

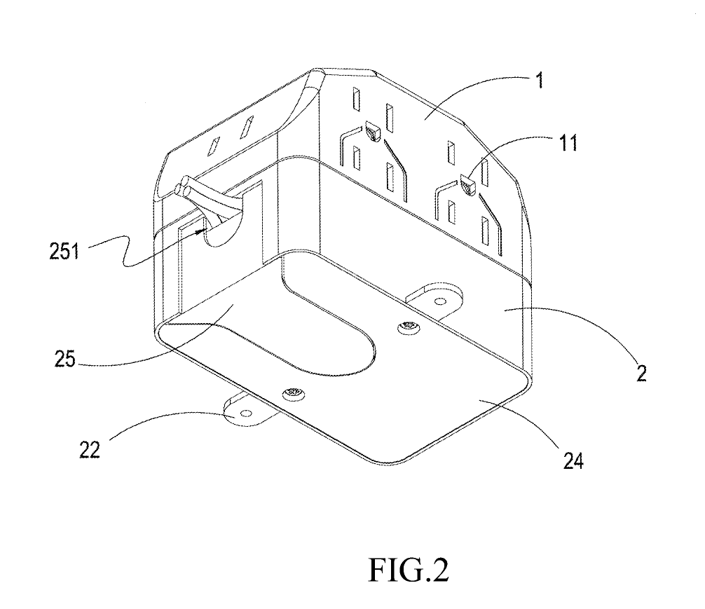

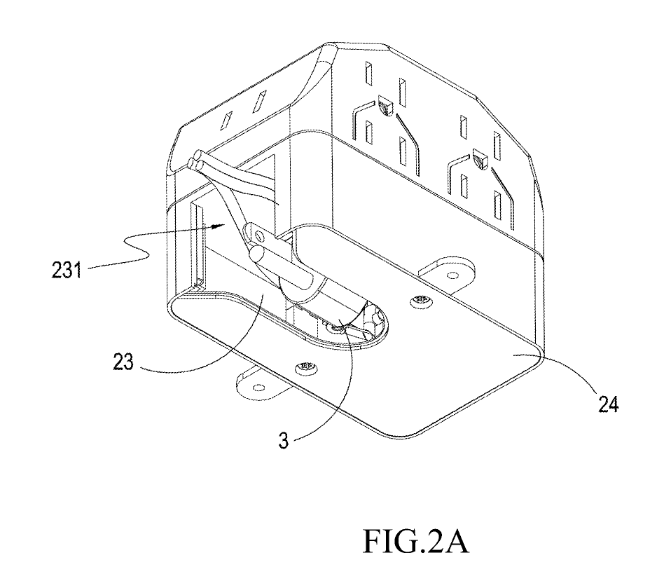

Further, FIG. 2A shows the rotary plug 3 is positioned within the receipt compartment 23 in parallel with respect to the main axis of the triple extension adaptor.

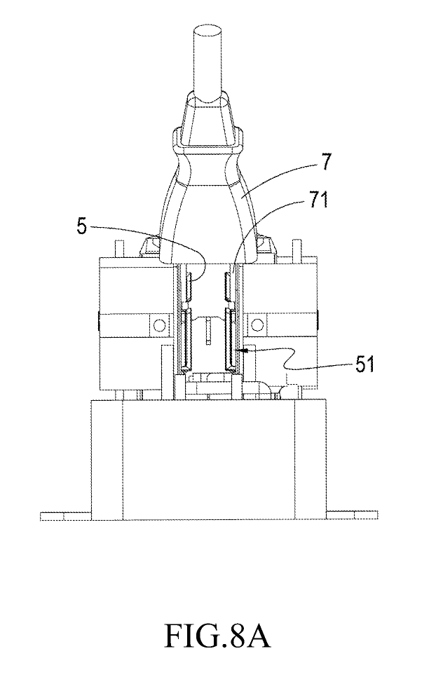

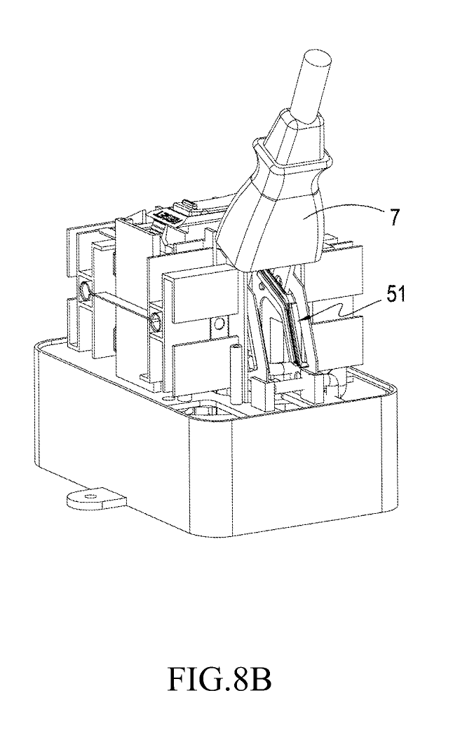

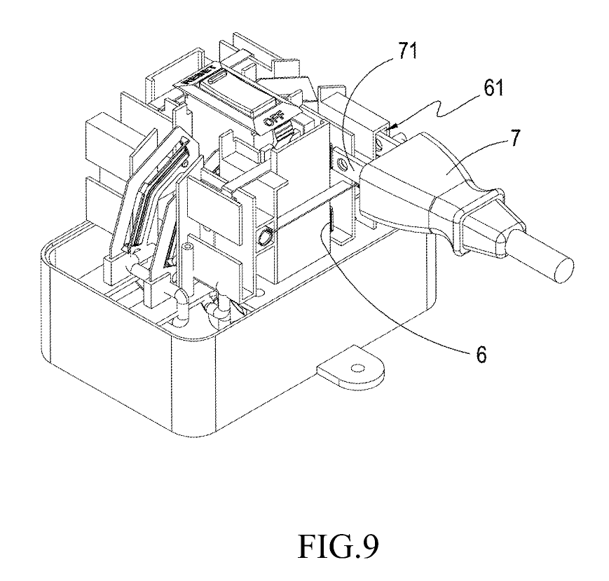

Please refer FIG. 1, FIG. 8A to FIG. 9. When plug 7 is inserted into the socket ports 11 from top of the cover 1, the conducting terminal 71 of the plug 7 is inserted into the first clamp lip 51 of the first NL terminal 5 so as to secure the plug 7 in position for transmitting electricity. Further, when plug 7 is inserted into the socket port 11 from the side of the cover 1, the conducting terminal 71 is inserted into the second clamp lip 61 of the second NL terminal 6 so as to secure the plug 7 in position for transmitting electricity.

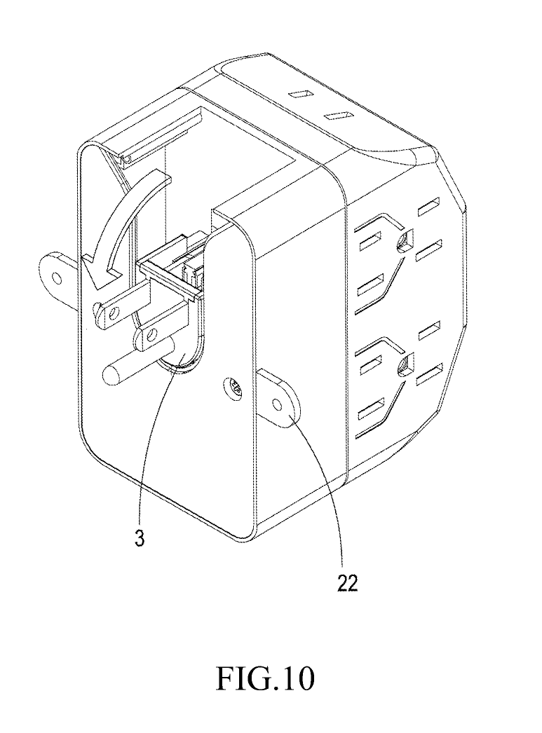

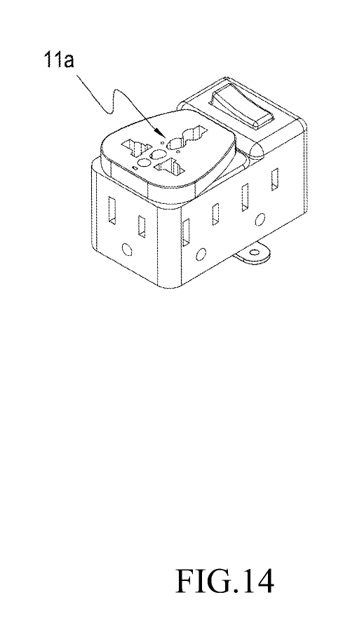

Please refer FIGS. 10 and 14. When the number of power supply sockets on wall is not sufficient for applications, the rotary plug 3 within the receipt compartment 23 can be turned in perpendicular position and then inserted into a wall socket 8 for electrical connection forming the expansion sockets. In addition, the securing flange 22 can be used to secure the triple extension adaptor in order to prevent falling off. In the mean time the triple extension adaptor can accommodate the plugs of German or French specifications as so to achieve the advantage of accommodating multiply plugs in different shapes, being used as extension cord for construction or household applications upon demand.

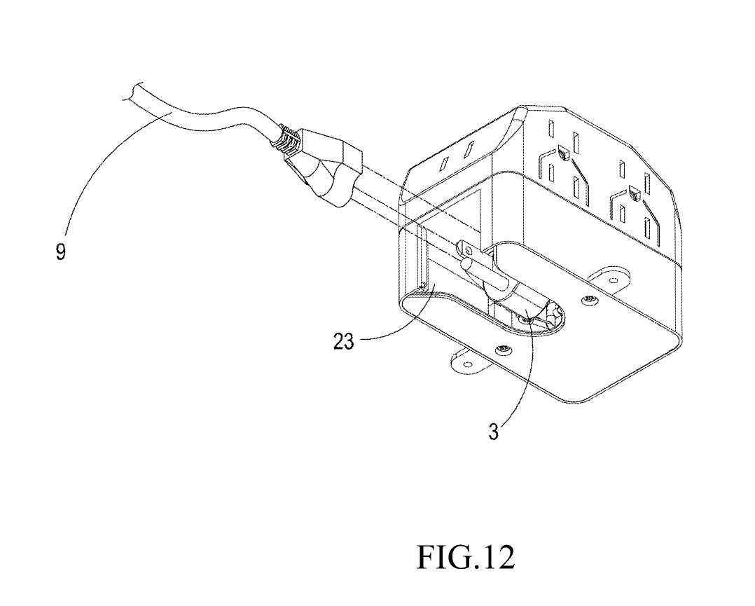

Please refer FIG. 12. The rotary plug 3 within the receipt compartment 23 can electrically connect a power supply wire 9 or an electrical supply tapping line (power supply wire 9 is used to illustrate this embodiment) so as to form an extension cord that further achieves the objective of extension cord in a safe manner.

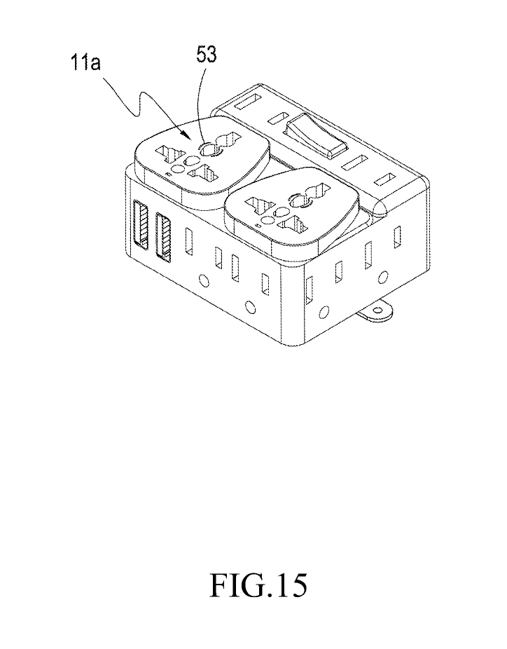

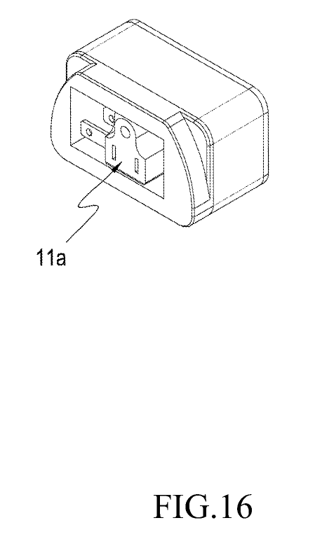

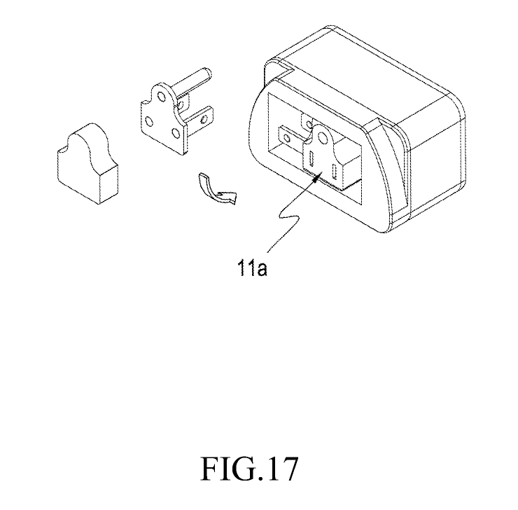

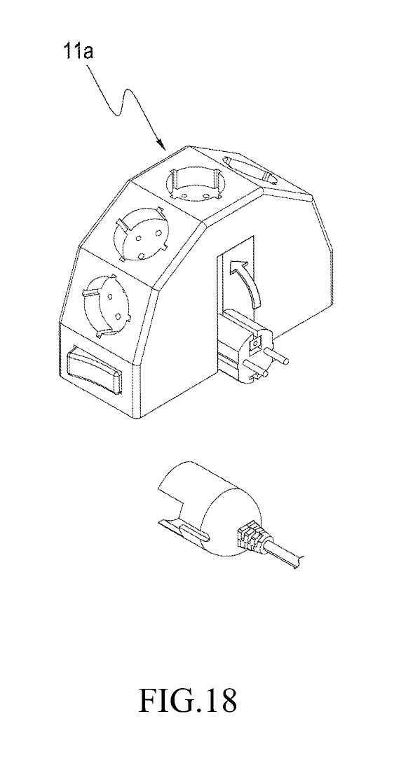

Please refer FIGS. 15 to 18. The triple extension adaptor of the present invention can be configured as the embodiments shown in FIGS. 15 to 18 in addition to the aforesaid embodiments, for instance, single pair of socket ports, double pair of socket ports and multiple pairs of socket ports. The socket ports 11a clearly show the specific design to accommodate the plugs of German or French specifications in FIGS. 15 to 18. Further, FIG. 15 shows an earth lip 53 is provided in order to comply with the technical feature of German plug specification.

In summary, the triple extension adaptor of the present invention has the following technical advantages over the prior art: accommodating multiply plugs in different shapes, connecting a power supply wire as extension cord for either construction or household applications by users and having an earth lip 53 provided at the surface of sockets so as to receive the plugs of German or French specifications with an earth connection.

It is to be understood that the embodiments of the present invention herein described are merely illustrative for the application of the present invention. Reference herein to details of the illustrated embodiments is not intended to limit the scope of the claims that recite the features regarded as essential to the present invention.

I claim:

1. A triple extension adaptor comprising:
a cover forming a plurality of socket ports in different shapes;
a bottom assembled with said cover, constituting a terminal stand for different terminals and a receipt compartment positioned within said bottom and provided with an opening at one side;
a rotary plug positioned within the receipt compartment and pivotally connected to said bottom through a plug rod and electrically connected to a plug connector also positioned within the receipt compartment and secured by a terminal clamp;
a wiring post positioned within the receipt compartment;
a bottom plate secured to said bottom; and
a lead shield snapped to said bottom for covering the opening so as to constitute a lead opening.

2. The triple extension adaptor of claim 1, wherein said bottom has at least one securing flange at one side.

3. The triple extension adaptor of claim 1, wherein said rotary plug can electrically connect to a wall socket so as to form an expansion adaptor with a plurality of sockets.

4. The triple extension adaptor of claim 1, wherein said rotary plug can electrically connect to a power supply wire so as to form an extension cord.

5. The triple extension adaptor of claim 1, wherein said wiring post is used to secure an electrical wire for construction applications.

6. The triple extension adaptor of claim 1, wherein the plurality of socket ports are designed to comply with the specific shapes of different plugs used in different countries.

7. The triple extension adaptor of claim 1, wherein said receipt compartment is provided with a plurality of first NL terminals in semi-sphere shape positioned with respect to the plurality of socket ports of said cover, each of the first NL terminals has at least a first clamp lip for securing a plug in position, and the plurality of first NL terminals is positioned in the terminal stand.

8. The triple extension adaptor of claim 1, wherein the receipt compartment is provided with a plurality of second NL terminals in [symbol] shape positioned with respect to the plurality of socket ports of said cover, each of the second NL terminals has at least a second clamp lip for securing a plug in position, and the plurality of second NL terminals is positioned in the terminal stand.

9. The triple extension adaptor of claim 1, wherein the terminal stand is provided for accommodating both the first and second NL terminals and an earth point.

10. The triple extension adaptor of claim 7, wherein the terminal stand is provided for accommodating both the first and second NL terminals and an earth point.

11. The triple extension adaptor of claim 8, wherein the terminal stand is provided for accommodating both the first and second NL terminals and an earth point.
